(19) United States
(12) Patent Application Publication
(10) Pub. No.: US 2014/0341339 A1
(43) Pub. Date: Nov. 20, 2014

(54) X-RAY TESTING FACILITY FOR DETECTING CERTAIN MATERIALS IN A TEST OBJECT

(71) Applicant: Smiths Heimann GmbH, Wiesbaden (DE)

(72) Inventor: Stefan AUST, Idstein (DE)

(21) Appl. No.: 14/449,719

(22) Filed: Aug. 1, 2014

Related U.S. Application Data
(63) Continuation of application No. PCT/EP2012/073708, filed on Nov. 27, 2012.

(30) Foreign Application Priority Data
Feb. 1, 2012 (DE) 10 2012 201 406.3

(51) Int. Cl. G01N 23/087; G01F 23/00

(52) U.S. Cl. CPC G01N 23/087; G01F 23/00
USPC 378/52; 378/53

(57) ABSTRACT

An x-ray testing facility for detecting certain materials in a test object, having a testing device containing a housing with a radiation tunnel, through which a transport device, particularly a transport conveyor for the test objects, passes, an x-ray generator arranged in the housing, which emits x-rays in a radiation plane, and a detector arrangement directed at the radiation plane. According to the invention, the x-ray testing facility contains an additional testing device which has a dedicated x-ray generator and an associated detector arrangement in a dedicated housing, wherein the x-ray generator emits x-rays, which are directed at the transport region of the test objects of the first testing device.

This nonprovisional application is a continuation of International Application No. PCT/EP2012/073708, which was filed on Nov. 27, 2012, and which claims priority to German Patent Application No. 10 2012 201 406.3, which was filed in Germany on Feb. 1, 2012, and which are both herein incorporated by reference.

### BACKGROUND OF THE INVENTION

1. Field of the Invention

The invention relates to an x-ray inspection system for detecting certain materials in an inspection object with an inspection device containing a housing with a radiation tunnel through which a transport device, particularly a conveyor belt, for the inspection objects passes, and an x-ray generator, which is arranged in the housing and emits x-rays in a radiation plane, and a detector array directed at the radiation plane.

2. Description of the Background Art

For the inspection of inspection objects, for example, for security inspections of luggage at airports, as is generally known, x-ray inspection systems are used in which the inspection object is conveyed through x-rays, emitted in a radiation plane and generated by x-ray generators. The x-rays not absorbed by the inspection objects are detected by associated detector arrays and evaluated by an evaluation unit. Simple inspection devices contain an x-ray generator. If the detection capability of the inspection systems is to be improved, then a known approach is to emit x-rays from two generators in a number of radiation planes. Such systems with a number of x-ray generators are complex and accordingly cost-intensive.

An example inspection system is described, for example, in WO 2009/127353 A1, which corresponds to US 20110091013, and which is incorporated herein by reference.

### SUMMARY OF THE INVENTION

It is therefore an object of the invention to provide an x-ray inspection system, which cost-effectively and with a lower structural complexity improves the material detection of prior-art x-ray inspection systems with a radiation plane, to also enable the detection of difficult to detect hazardous materials such as, e.g., liquids.

The object is attained in an embodiment by an additional inspection device, which has a dedicated x-ray generator in a dedicated housing and an associated detector array, whereby the x-ray generator of the additional inspection device emits x-rays directed at the transport area of the inspection objects of the first inspection device.

According to an embodiment of the invention, an existing x-ray inspection system, in which x-rays are emitted in a radiation plane, can be retrofitted simply and cost-effectively in order to obtain additional geometric information on the inspection objects to be examined. Thus, e.g., containers for liquids can be examined better for hazardous liquids without a new complete system having to be purchased.

Preferably, the x-ray generator of the additional inspection device has a lower acceleration voltage than the first x-ray generator.

The use of x-ray generators with an acceleration voltage of less than 130 kV, particularly of about 100 kV, requires little space and is cost-effective.

The additional inspection device is arranged either in front of or behind the main inspection device so that its x-ray generator is located in front of or behind the main inspection device laterally next to the transport device and above it. Or the additional inspection device is arranged so that its x-ray generator is located below the transport device.

If the x-ray generator of the additional inspection device is mounted movable up and down vertically, it can be used in particular to determine the liquid level in a liquid container. Alternatively or in addition, it can be mounted movable horizontally, particularly transverse to the transport direction of the inspection objects.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows as a sketch the principle of an x-ray inspection system with a stationary additional inspection device arranged laterally next to the transport device.

FIG. 2 shows as a sketch the arrangement of an additional x-ray generator below the transport device, whereby the x-ray generator is movable up and down vertically.

FIG. 3 shows an x-ray system with an additional inspection device, whose x-ray generator is arranged laterally and movable up and down vertically next to the transport device.

### DETAILED DESCRIPTION

The x-ray inspection systems described as exemplary embodiments are used for the security inspection of inspection objects 1, particularly luggage, as they are performed at airports. In this regard, inspection objects 1 are inspected with respect to their security relevance. A material discrimination occurs, which in the case of liquids also checks to determine whether they are hazardous (e.g., explosive) or safe.

The x-ray inspection system contains a first inspection device (main inspection device 2), which is constructed in a known manner. It contains a housing with a radiation tunnel 3 through which a transport device for inspection objects 1, particularly a conveyor belt 4, passes. A section perpendicular to the transport plane and perpendicular to the transport direction of inspection objects 1 is shown in the figures. These are conveyed for inspection perpendicular to the plane of the drawing through radiation tunnel 3.

An x-ray generator 5, which emits x-rays in a radiation plane 6, is arranged in the housing of main inspection device 2. A detector array directed at radiation plane 6 is also arranged in the housing. It is not shown in the figures. The x-rays not absorbed by the inspection objects are detected by associated detector arrays and evaluated by an evaluation unit.

According to the invention, the x-ray inspection system contains, in addition to the main inspection device 2, a further inspection device, which has a dedicated x-ray generator 7 in a dedicated housing. X-ray generator 7 emits x-rays, which are directed at the transport region of inspection objects 1 of the first inspection device (main inspection device 2). Like main inspection device 2, the additional inspection device in its housing contains an associated detector array, which is directed at radiation plane 8 of the x-rays of x-ray generator 7. Preferably, it also contains a dedicated computer unit to support the evaluation.

X-ray generator 7 of the additional inspection device preferably has a lower acceleration voltage and a lower anode current than x-ray generator 5 of main inspection device 2. It therefore has a lower output power than generator 5 of the main inspection device.

Preferably, x-ray generator 5 of main inspection device 2 has an acceleration voltage greater than 150 kV, particularly of about 160 kV. X-ray generator 7 of the additional inspection device preferably has an acceleration voltage of less than 130 kV, particularly of about 100 kV. Preferably, radiation planes 6, 8 of the x-rays, emitted by x-ray generator 5 and by additional x-ray generator 7, are parallel in order to simplify the evaluation.

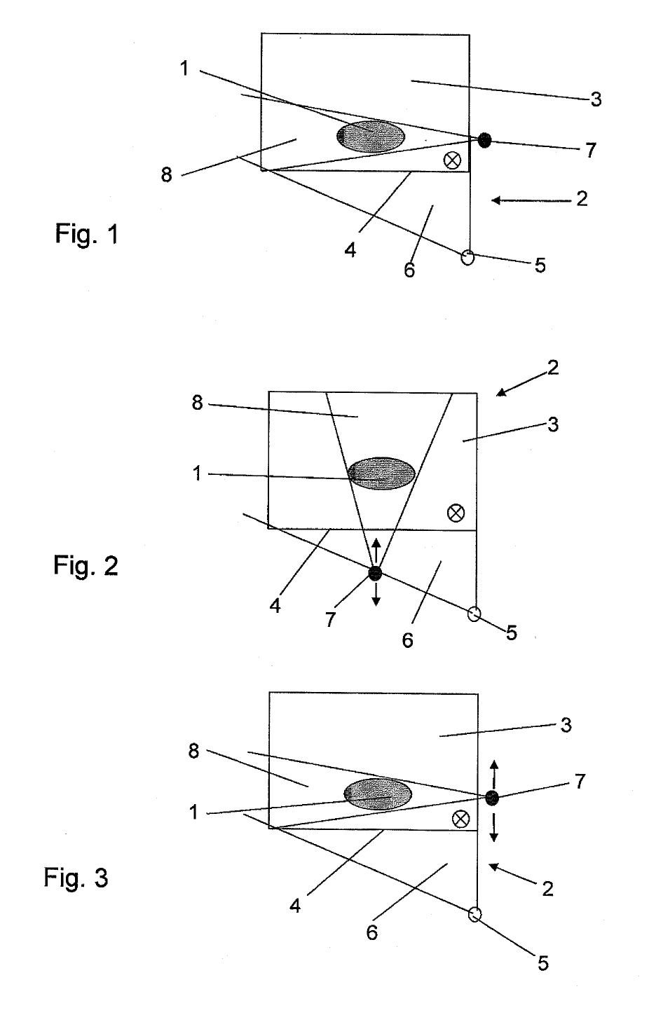

In the exemplary embodiments according to FIGS. 1 and 3, the additional inspection device is arranged so that its x-ray generator 7 is located in each case laterally next to the transport device (conveyor belt 4) and above it. In this case, the additional inspection device is arranged in each case in the transport direction of inspection objects 1 directly in front of or behind main inspection device 2.

In the embodiment according to FIG. 2, the additional inspection device is arranged so that its x-ray generator 7 is located below the transport device (conveyor belt 4). The x-rays of x-ray generator 7 thus penetrate conveyor belt 4 from below, which is made of a material transparent to x-rays.

X-ray generator 7 of the additional inspection device is mounted movable up and down vertically. The up and down movement of generator 7 is brought about by a vertical drive (not shown). Alternatively or in addition, generator 7 can also be mounted movable horizontally. The horizontal movement preferably occurs transverse to the transport direction. Thus, the geometry of an inspection object 1 can be determined more accurately with the additional inspection device.

The structure of the x-ray inspection system according to FIG. 3 corresponds to that of the system according to FIG. 1, in which the additional inspection device is arranged so that its x-ray generator 7 is located laterally next to the transport device (conveyor belt 4) and above it. In addition, x-ray generator 7 of the additional inspection device, as in the embodiment according to FIG. 2, is mounted movable up and down vertically and can be moved up and down by means of a vertical drive (not shown).

The additional inspection device has the object of supplying additional geometric information about inspection objects 1. In particular for the detection of liquid materials, geometric data should enable the determination of travel paths of the x-rays through the liquids. The vertical up and down movement of generator 7 offers the possibility of determining the height position of liquid levels.

A major advantage of the x-ray inspection system of the invention is that an existing inspection device with a high output power can be retrofitted by an additional inspection device, in order to improve the material discrimination, particularly to enable the inspection of liquids in containers. To this end, only minor conversion measures with a small additional space requirement are necessary.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An x-ray inspection system for detecting certain materials in an inspection object with an inspection device, the system comprising:
a housing with a radiation tunnel through which a transport device, particularly a conveyor belt, for the inspection objects passes;
an x-ray generator that is arranged in the housing and emits x-rays in a radiation plane;
a detector array directed at the radiation plane; and
an additional inspection device, which in a dedicated housing has a dedicated x-ray generator and an associated detector array, the dedicated x-ray generator emits x-rays directed at the transport area of the inspection objects of the first inspection device.

2. The x-ray inspection system according to claim 1, wherein the x-ray generator of the additional inspection device has a lower acceleration voltage than the first x-ray generator.

3. The x-ray inspection system according to claim 1, wherein the additional inspection device emits x-rays in a radiation plane, which is parallel to the radiation plane of the first inspection device.

4. The x-ray inspection system according to claim 2, wherein the x-ray generator of the first inspection device has an acceleration voltage greater than 130 kV and the x-ray generator of the additional inspection device has an acceleration voltage of less than 130 kV.

5. The x-ray inspection system according to claim 1, wherein the additional inspection device is arranged so that its x-ray generator is located laterally next to the transport device and above it.

6. The x-ray inspection system according to claim 1, wherein the additional inspection device is arranged so that its x-ray generator is located below the transport device.

7. The x-ray inspection system according to claim 5, wherein the additional inspection device is arranged directly in front of or behind the main inspection device.

8. The x-ray inspection system according to claim 5, wherein the x-ray generator of the additional inspection device is mounted movable up and down vertically.

9. The x-ray inspection system according to claim 5, wherein the x-ray generator of the additional inspection device is mounted movable horizontally, particularly transverse to the transport direction of the inspection objects.

10. The x-ray inspection system according to claim 1, wherein the transport device is a conveyor belt.
